(19) United States
(12) Patent Application Publication
(10) Pub. No.: US 2025/0043546 A1
(43) Pub. Date: Feb. 6, 2025

(54) MATERIAL SELECTION FOR A LOADING OPERATION PERFORMED BY A MACHINE

(71) Applicant: Caterpillar Inc., Peoria, IL (US)

(72) Inventors: Eric W. CLER, Oswego, IL (US); Aaron R. SHATTERS, Montgomery, IL (US)

(73) Assignee: Caterpillar Inc., Peoria, IL (US)

(21) Appl. No.: 18/362,841

(22) Filed: Jul. 31, 2023

(51) Int. Cl. E02F 9/26

(52) U.S. Cl. CPC E02F 9/262

(57) ABSTRACT

In some implementations, a controller of a machine may receive an indication of performance, by the machine, of a loading operation associated with a material. The controller may determine, based on the indication, a physical location associated with the loading operation. The controller may identify, based on the physical location, prior loading operation data. The controller may determine, based on the prior loading operation data, estimated identification information associated with the material. The controller may cause, based on the estimated identification information, one or more actions to be performed.

### TECHNICAL FIELD

The present disclosure relates generally to a machine and, for example, to facilitating selection of a material associated with a loading operation performed by the machine.

### BACKGROUND

To perform a loading operation, a machine, such as a wheel loader, can use an implement (e.g., a bucket or another implement) to load a material (e.g., asphalt, debris, dirt, snow, feed, gravel, logs, raw minerals, recycled material, rock, sand, woodchips, or similar material) into another machine, such as a dump truck, at a worksite, and/or to move the material from a first location to a second location at the worksite. In many cases, after completion of the loading operation, an operator of the machine interacts with a user interface of the machine to enter an identifier associated with the material (e.g., to allow the machine, or a system in communication with the machine, to record the material that was loaded as part of the loading operation). For example, the operator may select, via the user interface, the identifier from a list of material identifiers that is presented to the operator via a display of the machine. However, the operator often needs to “scroll” through the list, which requires that the operator provide many manual inputs into the user interface. Consequently, this process is time consuming and prone to error. This detrimentally impacts inventory management of materials at the worksite, which therefore affects planning and performance of subsequent loading operations (e.g., by the machine, or any number of other machines) at the worksite.

The controller of the present disclosure solves one or more of the problems set forth above and/or other problems in the art.

### SUMMARY

A machine comprising: an implement; a display; and a controller configured to: receive an indication of performance, by the machine using the implement, of a loading operation associated with a material; determine a physical location associated with the loading operation; determine, based on the physical location, estimated identification information associated with the material; and cause, based on the estimated identification information, one or more actions to be performed.

A method may include receiving, by a controller of a machine, an indication of performance, by the machine, of a loading operation associated with a material; determining, by the controller and based on the indication, a physical location associated with the loading operation; identifying, by the controller and based on the physical location, prior loading operation data; determining, by the controller and based on the prior loading operation data, estimated identification information associated with the material; and causing, by the controller and based on the estimated identification information, one or more actions to be performed.

A controller of a machine may include one or more memories; and one or more processors, coupled to the one or more memories, configured to: determine a physical location associated with a loading operation that is associated with a material; identify, based on the physical location, prior loading operation data; determine, based on the prior loading operation data, estimated identification information associated with the material; and cause, based on the estimated identification information, one or more actions to be performed.

### BRIEF DESCRIPTION OF THE DRAWINGS

FIG. 1 is a diagram of an example machine described herein.

FIGS. 2A-2D are diagrams of an example implementation described herein.

FIG. 3 is a diagram of example components of a device associated with material selection for a loading operation of a machine.

FIG. 4 is a flowchart of an example process associated with material selection for a loading operation of a machine.

### DETAILED DESCRIPTION

This disclosure relates to a controller of a machine (e.g., that performs a loading operation) and is applicable to any machine that is capable of moving material (e.g., from a first location to a second, different location) and/or loading the material (e.g., into another machine, such as dump truck). For example, the machine may be any machine that performs an operation associated with an industry such as, for example, mining, construction, farming, transportation, or any other industry. As some examples, the work machine may be a vehicle, a wheel loader, a backhoe loader, a cold planer, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or other above ground equipment, underground equipment, aerial equipment, or marine equipment.

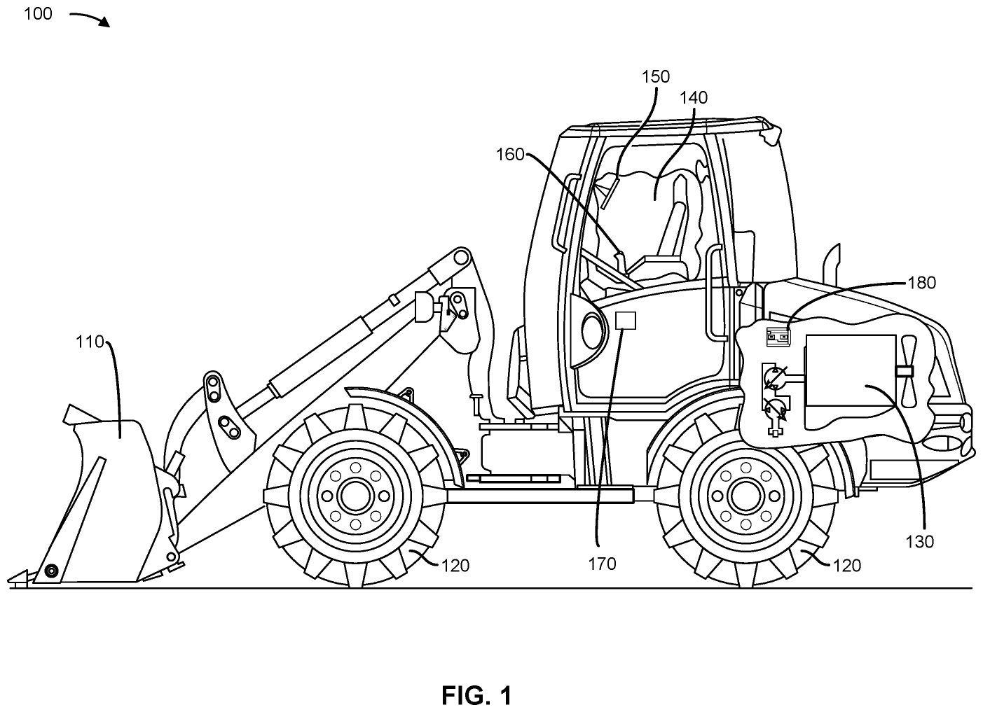

FIG. 1 is a diagram of an example machine 100 described herein. For example, the machine 100 may include a mobile machine, such as the wheel loader shown in FIG. 1, or any other type of mobile machine. Further, the machine 100 may be a manned machine or an unmanned machine. The machine 100 may be fully autonomous, semi-autonomous, or remotely operated. As shown in FIG. 1, the machine 100 may include an implement 110, one or more traction devices 120, an engine 130, an operator station 140 (e.g., that includes a display 150 and/or a user interface 160), one or more sensors 170, and/or a controller 180.

The implement 110 may include a bucket, a fork, a grapple, and/or any other type of implement for lifting, carrying, and depositing material (e.g., asphalt, debris, dirt, snow, feed, gravel, logs, raw minerals, recycled material, rock, sand, woodchips, or similar material) in association with a loading operation. The one or more traction devices 120 (sometimes referred to as ground engagements) are configured to facilitate propulsion of the machine 100 (e.g., movement of the machine 100) at a work site, and the engine 130 is configured to provide power to drive the one or more traction devices 120.

The operator station 140 provides a seat and controls for an operator to direct operations of the machine 100. Within the operation station 140 is the display 150, which may include a liquid crystal display (LCD) display, a light emitting diode (LED) display, or another type of display, that is configured to present (e.g., visually present) information to the operator. The operator station 140 may include other presentation devices, such as one or more speakers, one or more gauges, one or more indicator lights, and/or one or more haptic feedback devices, among other examples. Also within the operation station 140 is the user interface 160, which may include a dial, a joystick, a keyboard, a pedal, or another device, that is configured to allow the operator to enter information related to operating the machine 100.

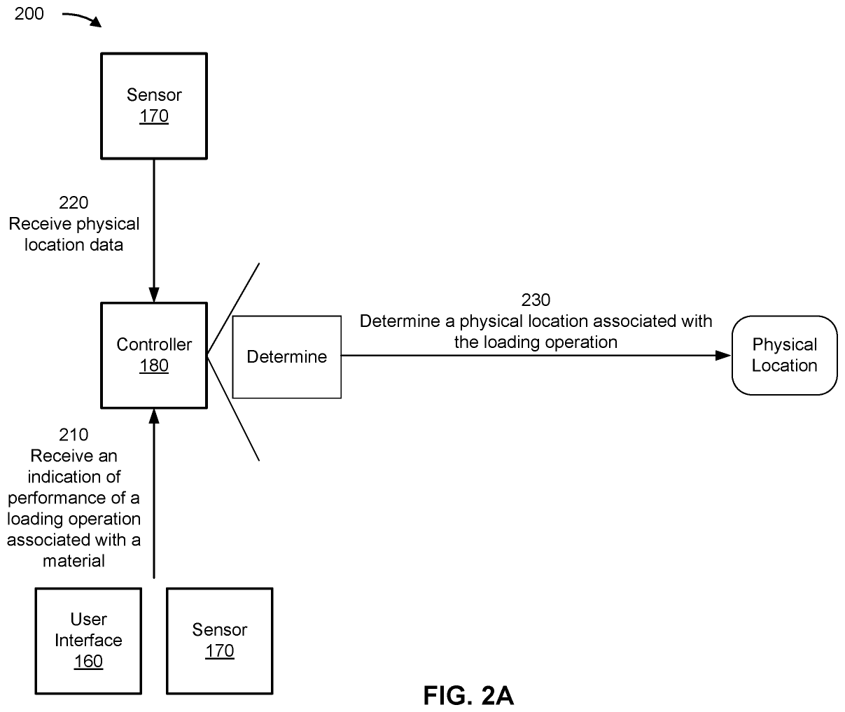

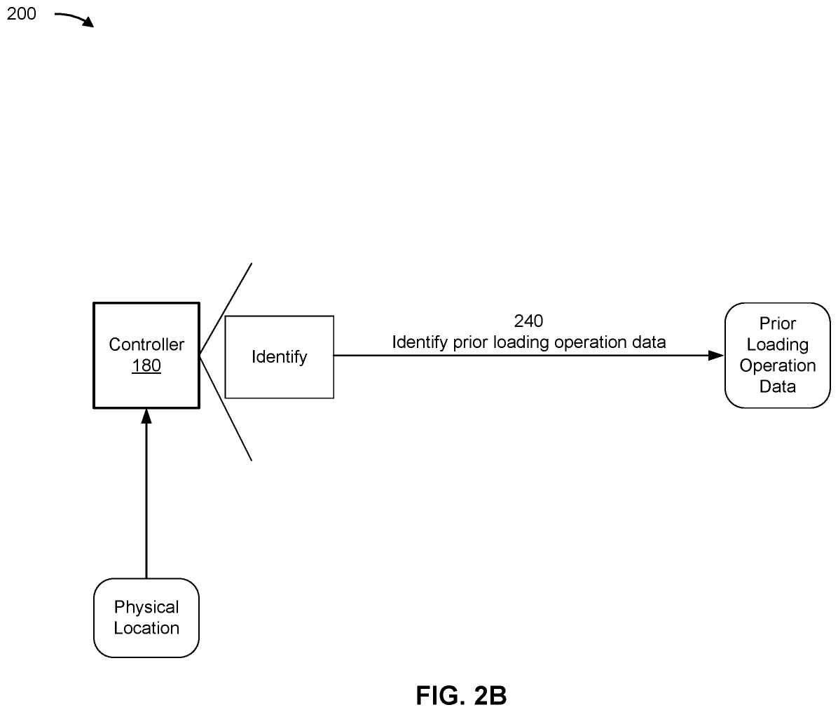

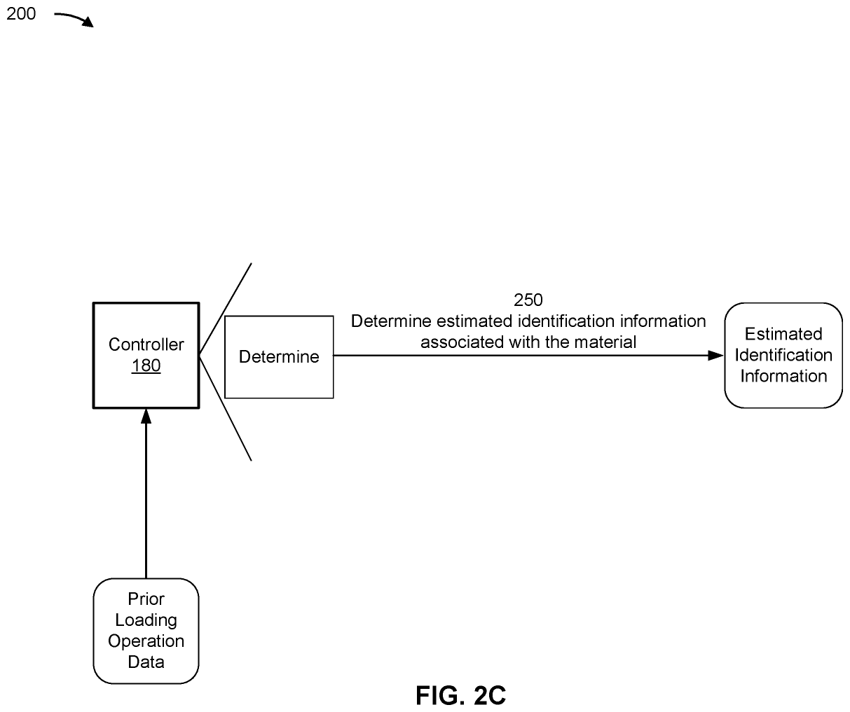

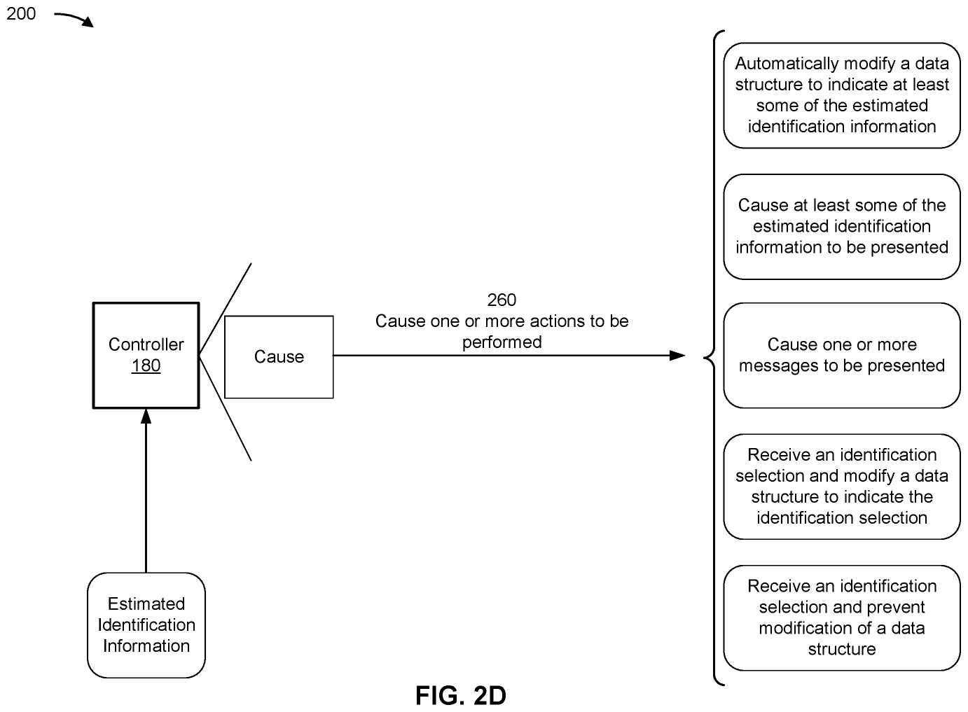

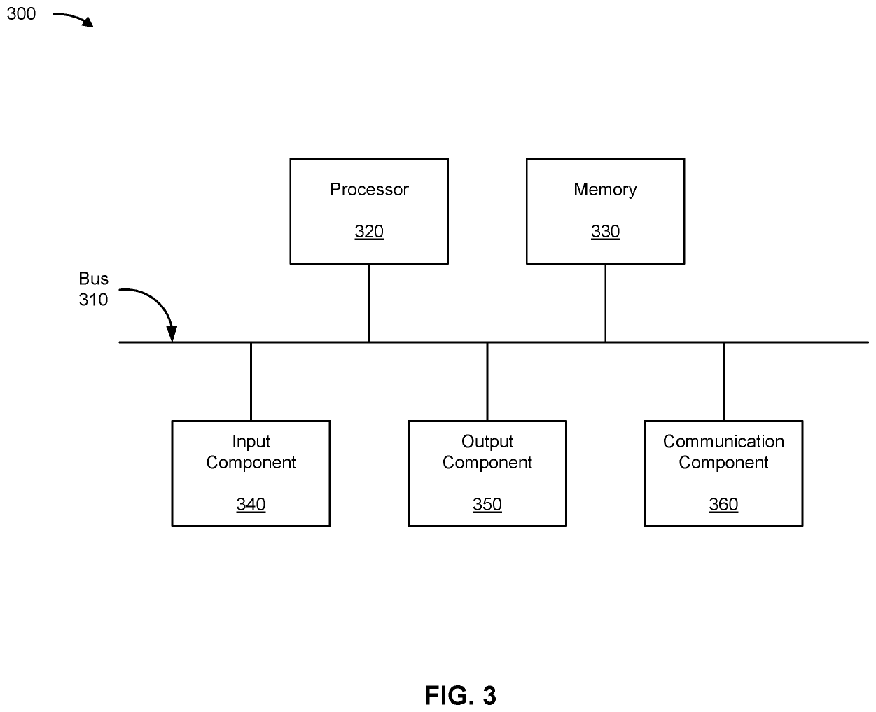

The one or more sensors 170 may include, for example, a location sensor (e.g., a global positioning system (GPS) sensor, a local positioning system sensor, or another type of location sensor) configured to determine a physical location of the machine 100, one or more load sensors (e.g., one or more pressure sensors, strain gauges, force gauges, and/or other sensors) configured to detect a pressure, a strain, a force, and/or another parameter associated with operation of the implement 110 (e.g., in association with the implement 110 lifting, carrying, and depositing material), and/or one or more other sensors. The controller 180 may include an electronic control module (ECM) or other computing device. The controller 180 may be configured to determine estimated identification information associated with a material (e.g., that is associated with a loading operation) and to cause one or more actions to be performed, as described herein. The controller 180 is further described herein in relation to FIGS. 2A-2D, and FIG. 3.

As indicated above, FIG. 1 is provided as an example. Other examples may differ from what is described in connection with FIG. 1.

FIGS. 2A-2D are diagrams of an example implementation 200 described herein. FIGS. 2A-2D show how the controller 180 facilitates selection of a material associated with a loading operation performed by the machine 100.

As shown in FIG. 2A, and by reference number 210, the controller 180 may receive an indication of performance (e.g., by the machine 100 using the implement 110) of a loading operation associated with a material. The loading operation may include, for example, using the implement 110 to lift, carry, and/or deposit the material (e.g., in one or more loads), such as from a first location to a second location at a work site (e.g., a different location than the first location at the worksite) and/or into another machine (e.g., a dump truck).

The controller 180 may receive the indication from a device of the machine 100 (e.g., that is associated with monitoring the loading operation). For example, an operator of the machine 100 (e.g., that is directing operation of the machine 100) may interact with the user interface 160 to cause the user interface 160 to generate and send the indication to the controller 180. As another example, the one or more sensors 170 (e.g., that includes one or more load sensors) may determine that the implement 110 has lifted, carried, and deposited (or is lifting, carrying, and depositing) a load of material (e.g., that is associated with the loading operation), and may thereby generate and send the indication to the controller 180. Accordingly, the controller 180 may receive the indication prior to performance of the loading operation (e.g., as an initial step before performance of the loading operation), during performance of the loading operation (e.g., while the machine is lifting, carrying, and/or depositing one or more loads of the material during the loading operation), or after performance of the loading operation (e.g., after completion of the loading operation).

As further shown in FIG. 2A, and by reference number 220, the controller 180 may receive physical location data. For example, the one or more sensors 170 (e.g., that includes a location sensor) may determine one or more physical locations of the machine 100 (e.g., represented as a latitude and a longitude, or another representation of physical location) in association with the loading operation, and may send the physical location data (e.g., that indicates the one or more physical locations) to the controller 180. In some implementations, the controller 180 may communicate with the one or more sensors 170 to cause the one or more sensors 170 to send the physical location data to the controller 180. For example, the controller 180 may request, upon receiving the indication of performance of the loading operation, the physical location data from the one or more sensors 170, and the one or more sensors 170, in response, may send the physical location data to the controller 180. The physical location data may indicate, for example, a particular physical location of the machine 100 in association with the loading operation (e.g., a physical location of the machine 100 when the controller 180 received the indication), or one or more physical locations of the machine 100 (e.g., associated with where the machine 100 was, or is, lifting, carrying, and/or depositing one or more loads) in association with the loading operation.

As shown by reference number 230, the controller 180 may determine a physical location associated with the loading operation. For example, the controller 180 may process the physical location data to determine the physical location. The physical location may be, for example, a representative physical location (e.g., an “average” physical location of the one or more physical locations indicated by the physical location data) associated with the loading operation. As an alternative example, the physical location may be a physical area (e.g., represented as a circle, an oval, or a polygon) associated with the loading operation (e.g., where the area bounds the one or more physical locations indicated by the physical location data).

As shown in FIG. 2B, and by reference number 240, the controller 180 may identify prior loading operation data (e.g., based on determining the physical location of the loading operation, as described herein in association with FIG. 2A). The prior loading operation data may be associated with the physical location of the loading operation. For example, the prior loading operation data may identify prior loading operations (e.g., performed by the machine 100, or another machine), respective material identifications associated with the prior loading operations (e.g., identifications of materials associated with the prior loading operations), respective physical locations associated with the prior loading operations (e.g., that are proximate to, or coextensive with, the physical location associated with the loading operation), and respective times (e.g., a minutes, hours, days, months, and/or years of performance of the prior loading operations) associated with the prior loading operations.

In some implementations, to identify the prior loading operation data, the controller 180 may identify, based on the physical location, a physical region. The physical region may be an expanded area of the physical location. For example, the physical region may be an expansion of a particular dimension (e.g., a radius, a length, or a width) of the physical location (e.g., of the representative physical location or the physical area indicated by the physical location) by an expansion amount. The expansion amount may be, for example, less than or equal to 1 meter (m), 5 m, 10 m, or 20 m. Accordingly, the controller 180 may search, based on the physical region, a data structure (e.g., a database, a table, or another type of data structure) that stores one or more entries that identify prior loading operations. Accordingly, based on searching the data structure, the controller 180 may identify one or more entries of the data structure, where each entry identifies, for example, a prior loading operation (e.g., performed by the machine 100, or another machine), a material identification of a material associated with the prior loading operation, a physical location associated with the prior loading operation (e.g., that is proximate to, or coextensive with the physical region), and/or a time associated with the prior loading operation (e.g., a minute, hour, day, month, and/or year of performance of the prior loading operation). Accordingly, the prior loading operation data may include the one or more entries

As shown in FIG. 2C, and by reference number 250, the controller 180 may determine (e.g., based on the prior loading operation data) estimated identification information associated with the material (e.g., that is associated with the loading operation). The estimated identification information may indicate one or more estimated identifications of the material, and may also indicate respective relevancy scores for the one or more estimated identifications.

In some implementations, to determine the estimated identification information associated with the material, the controller 180 may process the one or more entries of the data structure (e.g., that the controller 180 identified, and that are included in the prior loading operation data) to determine the estimated identification information. For example, the controller 180 may use an analysis technique, such as a recency-based analysis technique, to process the one or more entries. Accordingly, one or more recent entries, of the one or more entries, may be assigned a greater weight than less recent entries of the one or more entries. The controller 180 may then process, based on the respective weights of the one or more entries, the respective material identifications indicated by the one or more entries, to determine one or more estimated identifications of the material of the loading operation, and, in some implementations, respective relevancy scores for the one or more estimated identifications. Each respective relevancy score may be represented as a percentage, where a higher percentage indicates a higher likelihood that the associated estimated identification is relevant to the material (e.g., relevant to accurately identifying the material).

As shown in FIG. 2D, and by reference number 260, the controller 180 may cause one or more actions to be performed (e.g., based on the estimated identification information).

As shown in FIG. 2D, to cause the one or more actions to be performed, the controller 180 may automatically modify a data structure (e.g., to indicate at least some of the estimated identification information). For example, the controller 180 may identify a particular estimated identification of the material, of the one or more estimated identifications of the material (e.g., that are indicated by the estimated identification information), that has a particular relevancy score that is greater than or equal to relevancy scores of other estimated identifications of the one or more estimated identifications of the material. The controller 180 then may determine that the particular relevancy score satisfies a threshold (e.g., is greater than or equal to the threshold), and may thereby automatically modify, the data structure (e.g., that stores entries that identify prior loading operations) to indicate, for the loading operation, the particular estimated identification, the physical location of the loading operation, and a time (e.g., a current time) associated with the loading operation. The threshold may be, for example, greater than or equal to 50%, 65%, 75%, 85%, 95%, or 99%. In this way, the controller 180 may identify the most relevant estimated identification of the material and update the data structure to indicate the estimated identification.

As further shown in FIG. 2D, to cause the one or more actions to be performed, the controller 180 may cause at least some of the estimated identification information to be presented. For example, the controller 180 may cause at least some of the estimated identification information to be presented via the display 150 of the machine 100. For example, the controller 180 may cause at least some of the one or more estimated identifications of the material to be presented via the display 150 (e.g., in a list, such as sorted in a highest to lowest relevancy score order).

As further shown in FIG. 2D, the controller 180 may cause one or more messages to be presented. For example, the controller 180 may cause a message to be presented, via the display 150 and based on causing at least some of the estimated identification information to be presented, that indicates that the operator of the machine is to input, via the user interface 160 of the machine 100, an identification selection associated with the material (e.g., that indicates one of the one or more estimated identifications of the material, or another identification of the material). Accordingly, the operator may interact with the user interface 160 to input the identification selection, which causes the user interface 160 to send the identification selection to the controller 180.

As further shown in FIG. 2D, the controller 180 may thereby receive (e.g., via the user interface and based on causing the message to be presented), the identification selection. Accordingly, the controller 180 may modify the data structure based on the identification selection. For example, the controller 180 may modify the data structure to indicate, for the loading operation, the identification selection, the physical location, and a time (e.g., a current time) associated with the loading operation.

Alternatively, the controller 180 may determine whether the identification selection and the estimated identification information are consistent. For example, the controller 180 may determine whether the identification selection is included in the estimated identification information (e.g., whether the identification selection is one of the estimated identifications included in the estimated identification information). Based upon determining that the identification selection and the estimated identification information are consistent, the controller 180 may modify the data structure based on the identification selection (e.g., to indicate the identification selection, as described above). Based up determining that the identification selection and the estimated identification information are not consistent, the controller 180 may cause another message to be presented, via the display 150, that indicates that the operator of the machine 100 is to input, via the user interface 160, a response confirming or denying the identification selection. Accordingly, the operator may interact with the user interface 160 to input the response, which causes the user interface 160 to send the response to the controller 180. The controller 180 may thereby receive (e.g., via the user interface and based on causing the other message to be presented) the response. Based on receiving a response confirming the identification selection, the controller 180 may modify the data structure based on the identification selection (e.g., as described above). Alternatively, based on receiving a response denying the identification selection and as further shown in FIG. 2D, the controller 180 may prevent modification of the data structure (e.g., cause the data structure to not be updated based on the identification selection).

In some implementations, the controller 180 may receive (e.g., prior to receiving the indication of performance of the loading operation, described herein in relation to FIG. 2A) requested information. For example, the operator of the machine 100 (e.g., that is directing operation of the machine 100) may interact with the user interface 160 to cause the user interface 160 to generate and send the requested information to the controller 180. As another example, another device (e.g., that is not included in the machine), such as management device associated with managing the machine 100 and/or the worksite, may send the requested information to the controller 180 (e.g., via a wired and/or wireless connection between the machine 100 and the other device). The requested information may indicate a requested material associated with the loading operation. That is, the requested information may indicate a requested material that is to be loaded by the machine 100 as part of the loading operation.

Accordingly, to cause the one or more actions to be performed (e.g., as shown in FIG. 2D), the controller 180 may determine whether the requested material and the estimated identification information are consistent. For example, the controller 180 may determine whether the requested material is included in the estimated identification information (e.g., matches one of the estimated identifications included in the estimated identification information). Based upon determining that the requested material and the estimated identification information are consistent, the controller 180 may cause a message to be presented, via the display 150 of the machine 100, that indicates that the requested material and the estimated identification information are consistent (e.g., that the requested material is likely at the physical location of the performance of the loading operation). Based upon determining that the requested material and the estimated identification information are not consistent, the controller 180 may cause a message to be presented, via the display 150 of the machine 100, that indicates that the requested material and the estimated identification information are not consistent (e.g., that the requested material is likely not at the physical location of the performance of the loading operation).

As indicated above, FIGS. 2A-2D are provided as an example. Other examples may differ from what is described with regard to FIGS. 2A-2D.

FIG. 3 is a diagram of example components of a device 300 associated with facilitating selection of a material associated with a loading operation performed by a machine. The device 300 may correspond to the display 150, the user interface 160, the one or more sensors 170, and/or the controller 180. In some implementations, the display 150, the user interface 160, the one or more sensors 170, and/or the controller 180 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

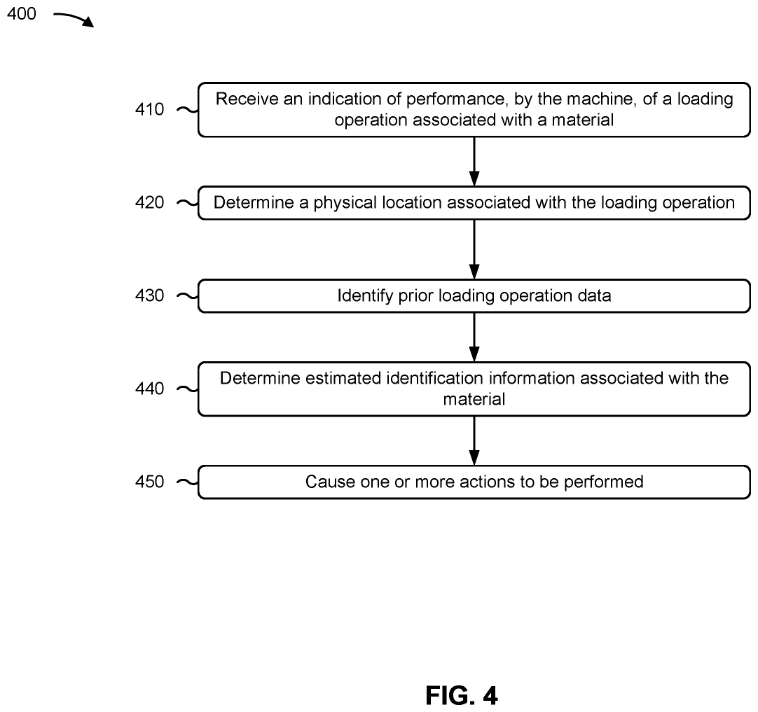

FIG. 4 is a flowchart of an example process 400 associated with material selection for a machine. One or more process blocks of FIG. 4 may be performed by a controller (e.g., the controller 180) of a machine (e.g., the machine 100). Additionally, or alternatively, one or more process blocks of FIG. 4 may be performed by another device or a group of devices separate from or including the controller, such as another device or component that is internal or external to the machine.

As shown in FIG. 4, process 400 may include receiving an indication of performance, by the machine, of a loading operation associated with a material (block 410). For example, the controller may receive an indication of performance, by the machine, of a loading operation associated with a material, as described above. The controller may receive the indication from a device of the machine associated with monitoring the loading operation

As further shown in FIG. 4, process 400 may include determining a physical location associated with the loading operation (block 420). For example, the controller may determine, based on the indication, a physical location associated with the loading operation, as described above.

As further shown in FIG. 4, process 400 may include identifying, based on the physical location, prior loading operation data (block 430). For example, the controller may identify, based on the physical location, prior loading operation data, as described above. Identifying the prior loading operation data may comprise identifying, based on the physical location, a physical region, and searching, based on the physical region, a data structure to identify one or more entries, wherein the one or more entries identify prior loading operations, respective material identifications associated with the prior loading operations, respective physical locations associated with the prior loading operations, and respective times associated with the prior loading operations.

As further shown in FIG. 4, process 400 may include determining estimated identification information associated with the material (block 440). For example, the controller may determine, based on the prior loading operation data, estimated identification information associated with the material, as described above. Determining the estimated identification information associated with the material may comprise processing, using a recency-based analysis technique, the one or more entries to determine the estimated identification information. The estimated identification information may indicate one or more estimated identifications of the material and respective relevancy scores for the one or more estimated identifications.

As further shown in FIG. 4, process 400 may include causing one or more actions to be performed (block 450). For example, the controller may cause, based on the estimated identification information, one or more actions to be performed, as described above.

Causing the one or more actions to be performed may comprise identifying, based on the estimated identification information, a particular estimated identification of the material, of the one or more estimated identifications of the material, that has a particular relevancy score that is greater than or equal to relevancy scores of other estimated identifications of the one or more estimated identifications of the material, determining that the particular relevancy score satisfies a threshold, and automatically modifying, based on determining that the particular relevancy score satisfies the threshold, a data structure to indicate, for the loading operation, the particular estimated identification, the physical location, and a time associated with the loading operation.

Causing the one or more actions to be performed may comprise causing at least some of the estimated identification information to be presented via a display of the machine, causing a message to be presented, via the display and based on causing at least some of the estimated identification information to be presented, that indicates that an operator of the machine is to input, via a user interface of the machine, an identification selection associated with the material, receiving, via the user interface and based on causing the message to be presented, the identification selection, and modifying a data structure to indicate, for the loading operation, the identification selection, the physical location, and a time associated with the loading operation.

Causing the one or more actions to be performed may comprise causing a message to be presented, via a display of the machine, that indicates that an operator of the machine is to input, via a user interface of the machine, an identification selection associated with the material, receiving, via the user interface and based on causing the message to be presented, the identification selection, determining that the identification selection and the estimated identification information are not consistent, and causing another message to be presented, via the display, that indicates that the operator of the machine is to input, via the user interface, a response confirming or denying the identification selection, and performing one of modifying, based on receiving a response confirming the identification selection, a data structure to indicate, for the loading operation, the identification selection, the physical location, and a time associated with the loading operation, or preventing, based on receiving a response denying the identification selection, modification of the data structure.

Process 400 may include receiving, prior to receiving the indication, requested information that indicates a requested material associated with the loading operation, and wherein causing the one or more actions to be performed comprises determining that the requested material and the estimated identification information are not consistent, and causing a message to be presented, via a display of the machine, that indicates that the requested material and the estimated identification information are not consistent.

Process 400 may include includes receiving, prior to receiving the indication, requested information that indicates a requested material associated with the loading operation, and wherein causing the one or more actions to be performed comprises determining that the requested material and the estimated identification information are consistent, and causing a message to be presented, via a display of the machine, that indicates that the requested material and the estimated identification information are consistent.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The disclosed controller (e.g., the controller 180) may be used in association with any machine that performs a loading operation associated with a material. The controller, based on receiving an indication of performance of the loading operation (e.g., from another device of the machine), determines a physical location associated with the loading operation (e.g., a physical location of the machine in association with performing the loading operation). The controller, based on the physical location, identifies prior loading operation data (e.g., that identifies prior loading operations associated with the physical location), and thereby identifies estimated identification information associated with the material. The estimated identification information indicates one or more estimated identifications of the material. Accordingly, the controller causes one or more actions to be performed. For example, the controller may automatically update a data structure to indicate that the material is a most likely estimated identification included in the estimated identification information. As another example, the controller may cause at least some of the estimated identification information to be presented (e.g., as a sorted list, with the most relevant estimated identification listed first) via a display of the machine. This increases a likelihood that the operator selects a relevant identification selection of the material. Accordingly, the controller may update the data structure to indicate the identification selection.

In this way, the controller reduces an amount of time that is needed to update a data structure that tracks loading operations of the machine (and other machines), such as at a worksite. The controller also reduces (or eliminates) an amount of time that an operator needs to expend, and a quantity of inputs that operator needs to input, when interacting with a user interface to select a material associated with a loading operation. This therefore reduces an amount of idle time that the machine is not actively performing a loading operation, increases an efficiency of the machine. Thus, over an operable lifetime of the machine, the machine is able to perform more loading operations, and/or perform them more efficiently, than a machine does not include the controller disclosed herein.

Further, the controller decreases a likelihood that a material associated with a loading operation is misidentified (e.g., in the data structure that tracks prior loading operations). This improves an accuracy and quality of the data related to prior loading operations stored in the data structure. Accordingly, the enables improved inventory management of materials at a worksite. This reduces a likelihood that the machine, as well any other machine at the worksite, performs incorrect or unnecessary load operations, and thereby reduces unnecessary wear and tear on the machine (and any other machine that would otherwise need to perform additional loading operations). By reducing unnecessary loading operations, an efficiency of the machine and other machines at the worksite are improved. Also, waste is reduced, such as of misidentified material that cannot be used and/or of resources (e.g., fuel and/or parts) that are needed to operate the machines in association with unnecessary loading operations.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A machine comprising:
an implement;
a display; and
a controller configured to:
receive an indication of performance, by the machine using the implement, of a loading operation associated with a material;
determine, based on the indication, a physical location associated with the loading operation;
determine, based on the physical location, estimated identification information associated with the material; and
cause, based on the estimated identification information, one or more actions to be performed.

2. The machine of claim 1, wherein the estimated identification information indicates one or more estimated identifications of the material and respective relevancy scores for the one or more estimated identifications.

3. The machine of claim 2, wherein the controller, to cause the one or more actions to be performed, is configured to:
identify, based on the estimated identification information, a particular estimated identification of the material, of the one or more estimated identifications of the material, that has a particular relevancy score that is greater than or equal to relevancy scores of other estimated identifications of the one or more estimated identifications of the material;
determine that the particular relevancy score satisfies a threshold; and
automatically modify, based on determining that the particular relevancy score satisfies the threshold, a data structure to indicate, for the loading operation, the particular estimated identification, the physical location, and a time associated with the loading operation.

4. The machine of claim 1, wherein the controller, to receive the indication, is configured to:
receive the indication from a device of the machine associated with monitoring the loading operation.

5. The machine of claim 1, wherein the controller, to determine the estimated identification information associated with the material, is configured to:
identify, based on the physical location, a physical region;
search, based on the physical region, a data structure to identify one or more entries,
wherein the one or more entries identify prior loading operations, respective material identifications associated with the prior loading operations, respective physical locations associated with the prior loading operations, and respective times associated with the prior loading operations; and
process the one or more entries to determine the estimated identification information.

6. The machine of claim 1, wherein the controller, to cause the one or more actions to be performed, is configured to:
cause at least some of the estimated identification information to be presented via the display.

7. A method, comprising:
receiving, by a controller of a machine, an indication of performance, by the machine, of a loading operation associated with a material;
determining, by the controller and based on the indication, a physical location associated with the loading operation;
identifying, by the controller and based on the physical location, prior loading operation data;
determining, by the controller and based on the prior loading operation data, estimated identification information associated with the material; and
causing, by the controller and based on the estimated identification information, one or more actions to be performed.

8. The method of claim 7, wherein the estimated identification information indicates one or more estimated identifications of the material and respective relevancy scores for the one or more estimated identifications.

9. The method of claim 8, wherein causing the one or more actions to be performed comprises:
identifying, based on the estimated identification information, a particular estimated identification of the material, of the one or more estimated identifications of the material, that has a particular relevancy score that is greater than or equal to relevancy scores of other estimated identifications of the one or more estimated identifications of the material;
determining that the particular relevancy score satisfies a threshold; and
automatically modifying, based on determining that the particular relevancy score satisfies the threshold, a data structure to indicate, for the loading operation, the particular estimated identification, the physical location, and a time associated with the loading operation.

10. The method of claim 7, wherein identifying the prior loading operation data comprises:
identifying, based on the physical location, a physical region; and
searching, based on the physical region, a data structure to identify one or more entries,
wherein the one or more entries identify prior loading operations, respective material identifications associated with the prior loading operations, respective physical locations associated with the prior loading operations, and respective times associated with the prior loading operations.

11. The method of claim 10, wherein determining the estimated identification information associated with the material comprises:
processing, using a recency-based analysis technique, the one or more entries to determine the estimated identification information.

12. The method of claim 7, wherein causing the one or more actions to be performed comprises:
causing at least some of the estimated identification information to be presented via a display of the machine;
causing a message to be presented, via the display and based on causing at least some of the estimated identification information to be presented, that indicates that an operator of the machine is to input, via a user interface of the machine, an identification selection associated with the material;
receiving, via the user interface and based on causing the message to be presented, the identification selection; and
modifying a data structure to indicate, for the loading operation, the identification selection, the physical location, and a time associated with the loading operation.

13. The method of claim 7, wherein causing the one or more actions to be performed comprises:
receiving, via the user interface, an identification selection associated with the material;
determining that the identification selection and the estimated identification information are not consistent; and
causing another message to be presented, via the display, that indicates that the operator of the machine is to input, via the user interface, a response confirming or denying the identification selection; and
performing one of:
modifying, based on receiving a response confirming the identification selection, a data structure to indicate, for the loading operation, the identification selection, the physical location, and a time associated with the loading operation, or
preventing, based on receiving a response denying the identification selection, modification of the data structure.

14. The method of claim 7, further comprising:
receiving, prior to receiving the indication, requested information that indicates a requested material associated with the loading operation, and
wherein causing the one or more actions to be performed comprises:
determining that the requested material and the estimated identification information are not consistent; and
causing a message to be presented, via a display of the machine, that indicates that the requested material and the estimated identification information are not consistent.

15. The method of claim 7, further comprising:
receiving, prior to receiving the indication, requested information that indicates a requested material associated with the loading operation, and
wherein causing the one or more actions to be performed comprises:
determining that the requested material and the estimated identification information are consistent; and
causing a message to be presented, via a display of the machine, that indicates that the requested material and the estimated identification information are consistent.

16. A controller of a machine, comprising:
one or more memories; and
one or more processors, coupled to the one or more memories, configured to:
determine a physical location associated with a loading operation that is associated with a material;
identify, based on the physical location, prior loading operation data;
determine, based on the prior loading operation data, estimated identification information associated with the material; and
cause, based on the estimated identification information, one or more actions to be performed.

17. The controller of claim Error! Reference source not found.6, wherein the estimated identification information indicates one or more estimated identifications of the material.

18. The controller of claim Error! Reference source not found. 7, wherein the one or more processors, to cause the one or more actions to be performed, are configured to:
identify, based on the estimated identification information, a particular estimated identification of the material, of the one or more estimated identifications of the material, that has a particular relevancy score that is greater than or equal to relevancy scores of other estimated identifications of the one or more estimated identifications of the material; and
automatically update, based on identifying the particular estimated identification of the material, a data structure to indicate, for the loading operation, the particular estimated identification, the physical location, and a time associated with the loading operation.

19. The controller of claim Error! Reference source not found.6, wherein the one or more processors, to cause the one or more actions to be performed, are configured to:
cause at least some of the estimated identification information to be presented via a display of the machine.

20. The controller of claim Error! Reference source not found.6, wherein the one or more processors, to cause the one or more actions to be performed, are configured to:
cause at least some of the estimated identification information to be presented via a display of the machine;
receive, via a user interface of the machine and based on causing at least some of the estimated identification information to be presented, an identification selection associated with the material; and
modify a data structure to indicate, for the loading operation, the identification selection, the physical location, and a time associated with the loading operation.
